(19) United States
(12) Patent Application Publication
(10) Pub. No.: US 2006/0184965 A1
(43) Pub. Date: Aug. 17, 2006

(54) Method for providing electronic program guide for digital broadcasting

(75) Inventors: Byoung-Dai Lee, Seongnam-si (KR); Kwan-Soo Lee, Seoul (KR); Young-Seop Han, Suwon-si (KR); Yun-Je Oh, Yongin-si (KR); Young-Jip Kim, Suwon-si (KR)

Correspondence Address: CHA & REITER, LLC, 210 ROUTE 4 EAST STE 103, PARAMUS, NJ, 07652, US

(73) Assignee: Samsung Electronics Co; LTD

(21) Appl. No.: 11/345,020

(22) Filed: Feb. 1, 2006

(30) Foreign Application Priority Data
Feb. 15, 2005 (KR) 2005-12345

(51) Int. Cl. H04N 5/445; G06F 3/00; G06F 13/00

(52) U.S. Cl. 725/39; 725/40; 725/41; 725/48

(57) ABSTRACT

Disclosed is a method for providing an electronic program guide (EPG) for digital broadcasting. The method includes the steps of analyzing motion picture experts group (MPEG)-2 transport stream for the digital broadcasting by a digital broadcasting receiver of a digital broadcasting subscriber as the digital broadcasting subscriber executes an electronic program guide (EPG) function, obtaining a PID of an elementary stream, which transmits an object carousel, by analyzing a program map table (PMT) of the motion picture experts group (MPEG)-2 transport stream if an application program is transmitted, downloading the application program using the PID information of the elementary stream and then storing the application program in a temporary storage device, displaying electronic program guide information through display of the digital broadcasting subscriber, and executing the application program when contents relating to the application program are selected in electronic program guide information.

### CLAIM OF PRIORITY

This application claims priority to an application entitled “Method for Providing Electronic Program Guide for Digital Broadcasting,” filed in the Korean Intellectual Property Office on Feb. 15, 2005 and assigned Serial No. 2005-12345, the contents of which are incorporated herein by reference.

### BACKGROUND OF THE INVENTION

1. Field of the Invention

The present invention relates to digital broadcasting, and more particularly to a method of providing an electronic program guide in a digital broadcasting field.

2. Description of the Related Art

The development of digital techniques brings a digital broadcasting service of transmitting a digital stream to enable a user to enjoy higher-definition broadcast images on a television.

When this digital broadcasting service is employed, it is possible to simultaneously transmit additional information (e.g., time and detailed information about each channel program and an application program) as well as a simple image/voice. In addition, a rapid development of a network technique enables a bi-directional broadcasting service allowing a real-time participation by a user in a program.

Accordingly, a digital broadcasting data service enabling a user to obtain each transmitted channel information must be provided as an indispensable function in the future digital broadcasting service. That is, it is necessary to perform a function to easily search additional information (e.g., program time and detailed information for each channel and an application program) being broadcasted or to be broadcasted in the near future.

A scheme for transmitting additional information used in the conventional analog broadcasting service allows a broadcasting operator to transmit the program information by allocating one channel for the program information because the program information and an application program cannot be transmitted together with a video signal. For example, a recent cable broadcasting service uses one specific broadcasting channel as a broadcasting channel to be used for providing information required by a cable broadcasting service operator.

However, in the case of the digital broadcasting service, broadcasting program information can be transmitted through the service information (SI) of program specific information (PSI) within a motion picture experts group (MPEG)-2 stream (in the case of an European DVB digital broadcasting scheme) and system information protocol (in the case of an America ATSC digital broadcasting scheme). Terminals such as a TV and a set-top box provide the information included in the MPEG-2 stream to a broadcasting service user by parsing the information included in the MPEG-2 stream when the broadcasting service user executes an electronic program guide function.

However, since the conventional electronic program guide (EPG) function in a digital broadcasting receiver parses only SI or PSIP information within the MPEG-2 stream, the function can provide only the time information and information about summary/detailed contents of a program being broadcasted or to be broadcasted in the future through each digital broadcasting channel. Accordingly, the broadcasting service user must personally change to each channel and search each channel in order to determine if an application program transmitted within a digital broadcasting program exists and execute the corresponding application program.

### SUMMARY OF THE INVENTION

Accordingly, the present invention has been made to solve the above-mentioned problems occurring in the prior art and provides additional advantages, by providing an electronic program guide (EPG) for digital broadcasting, which enables a digital broadcasting user to receive the program information of each channel and information about the existence of an application program provided in a corresponding channel through an EPG program, thereby helping the digital broadcast user to select the desired channel.

In one embodiment, there is provided a method for providing an electronic program guide (EPG) for digital broadcasting, the method comprising the steps of analyzing motion picture experts group (MPEG)-2 transport stream for the digital broadcasting by a digital broadcasting receiver of a digital broadcasting subscriber as the digital broadcasting subscriber executes an electronic program guide (EPG) function, obtaining a PID of an elementary stream, which transmits an object carousel, by analyzing a program map table (PMT) of the motion picture experts group (MPEG)-2 transport stream if an application program is transmitted, downloading the application program using the PID information of the elementary stream and then storing the application program in a temporary storage device, displaying electronic program guide information through display of the digital broadcasting subscriber, and executing the application program when contents relating to the application program are selected in electronic program guide information.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating a digital broadcasting system;

FIG. 2 is a flowchart illustrating a method for providing an electric program guide for digital broadcasting according an embodiment of the present invention; and

FIGS. 3A to 3D are views illustrating operation steps of providing an electric program guide for digital broadcasting according to the present invention.

### DETAILED DESCRIPTION

Hereinafter, embodiments of the present invention will be described in detail with reference to the accompanying drawings. For the purposes of clarity and simplicity, a detailed description of known functions and configurations incorporated herein will be omitted as it may make the subject matter of the present invention unclear.

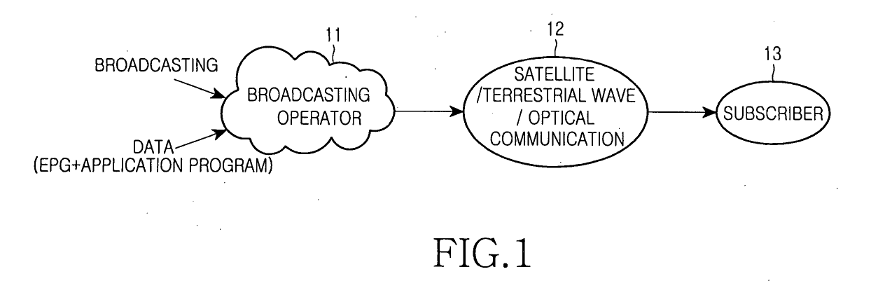

FIG. 1 is a block diagram illustrating a digital broadcasting system whereto the embodiment of the present invention is applicable.

The digital broadcasting system includes: a broadcasting operator 11 for transmitting broadcasting signals, which form individual broadcasting services, and data information according to the broadcasting signals as a transport stream by multiplexing the broadcasting signals and the data information; a variety of transport media 12 for transmitting the multiplexed transport stream; and a subscriber 13 for receiving the transmitted transport stream, detecting a desired stream in the transport stream, and benefiting the broadcasting service according to the desired stream.

In the multiplexing of data information according to the broadcasting signals by the broadcasting operation 11, the data information includes contents for several individual programs provided and information about the types of the programs.

The data information denotes service information or program guide information, and currently opened standards for the data information include a European DVB standard and an American ATSC standard.

The European DVB standard defines the service information transmission for digital broadcasting using the MPEG-2 standard based on service information (SI) of program specific information (PSI) on an MPEG-2 system layer. The PSI delivers information allowing a receiver to de-multiplex and decode a specific stream in a multiplexed stream. The PSI includes a program association table (PAT), a conditional access table (CAT), a program map table (PMT), and a network information table (NIT) defined in the MPEG-2 standard.

In addition, the European DVB standard suggests guide information for a service and an individual program provided to the subscriber 13 in addition to such a PSI and defines six tables for the guide information. The six tables includes a bouquet association table (BAT), a service description table (SDT), an event information table (EIT), a running status table (RST), a time and date table (TDT), and a stuffing table (ST).

In the present invention, although the embodiment for the ATSC standard is employed instead of that for the DVB standard in view of service information of digital broadcasting, it should be noted that the embodiment for the DVB standard may be analogically employed based on the embodiment of the ATSC standard.

Hereinafter, the format for the service information of digital broadcasting in the ATSC standard will be described according to an embodiment of the present invention.

In the American ATSC standard, program guide and channel transmission information are transmitted by combining program and system information protocol (PSIP) tables. The PSIP tables are constructed as six tables including a system time table (STT), a rating region table (RRT), a master guide table (MGT), a virtual channel table (VCT), an event information table, and an extended time table (ETT). The program guide in the American ATSC standard has a structure more simple than that of the European DVB standard. The program guide in the American ATSC standard, mainly selects a plurality of broadcasting programs transmitted through one physical channel and has the distribution according to time, the rating of a program, and brief description about program information of an individual event program to be broadcasted in a corresponding broadcasting program.

Now, the characteristic and the function of each table included in the PSIP will be described. The MGT forms relationship between other tables included in the PSIP and allocates the required capacity of a memory for the PSIP while a receiver performs decoding. In addition, the MGT transmits a PID of an EIT-x table in order to provide information about the EIT-x table which temporally delivers guide information about an individual program. Further, the MGT provides a link among an EIT-0 table, an EIT-1 table, and an EIT-2 table. Therefore, the MGT expresses the change of contents thereof by increasing the version number.

The VCT includes information about several channels, which is delivered through a physical terrestrial broadcasting channel and is called a terrestrial VCT. The VCT delivers the type of a broadcasting program, a modulation scheme for delivering the channel, and information about source_id corresponding to a frequency of a channel and an individual broadcasting included in the name of a channel and the channel.

The RRT delivers information about the rating of the TV programs according to regions because the rating of the TV program differs depending on regions. Herein, the RRT may have a low frequency of transmission because the rating of the TV program is not frequently changed.

The STT provides information about the current time and the date and time information including a difference between a global positioning system (GPS) time and a universal coordinated (UTC) time.

The EIT is used for providing program guide information and is constructed according to time slots. One EIT has 3-hour program guide information. The maximum of 128 EITs may be used, and a broadcasting corporation may advertise the maximum of 16-day program guide information using the 128 EITs. On the assumption that an EIT-0 transmits 3-hour program guide information after a current time, the EIT-I includes next 3-hour program guide information. In addition, it is defined that each transport packet includes at least four EITs. In other words, each of the EIT-0, the EIT-1, and the EIT-2 shows a guide table for each time slot. It is possible to benefit the program guide according to time slots for corresponding broadcasting because the EIT-0, the EIT-1, and the EIT-2 are considered for each broadcasting program to be searched using the source_id including guide information about each broadcasting program or an individual elementary stream.

An extended time table (ETT) is used for transmitting brief text information by adding the brief text information to the VCT or the EIT for transmitting channel information or program guide information. Accordingly, this ETT allows plenty of delivery contents. That is, when information about costs for channel reception and guide of a next program is inserted into the VCT, and when program guide about a film is inserted by the EIT, brief description about a corresponding film through the ETT allows superior program guide.

The present invention suggests that an application information table (AIT) for displaying information about an application program is added to the six information tables. In other words, the AIT, which provides application program information included in each program, is inserted into the EIT/ETT, which explain each program, thereby reporting the existence of an application program and enabling the execution of the application program when EPG information is displayed. Although the present invention suggests that the AIT is added to the six information tables in the ATSC standard, it is generally known to those skilled in the art that the AIT may be added based on the DVB standard.

Herein, the AIT has information representing whether or not an application program is included in each program and the position information about the application program.

Information relating to a program and an application program according to the present invention is delivered through the EIT/ETT and the AIT, respectively.

As described above, the MPEG-2 elementary stream delivering the information tables may be received by analyzing the PMT.

In this case, although stream types, which are used for searching elementary streams actually transmitted, may vary depending on data broadcasting standards (MHP, OCAP, and ACAP) according to physical transport media, this may not exert an influence upon the present invention.

Hereinafter, the present invention will be described based on an MHP standard of a satellite broadcasting for the purpose of description even though the present invention is not affected by data broadcasting standards according to physical transport media.

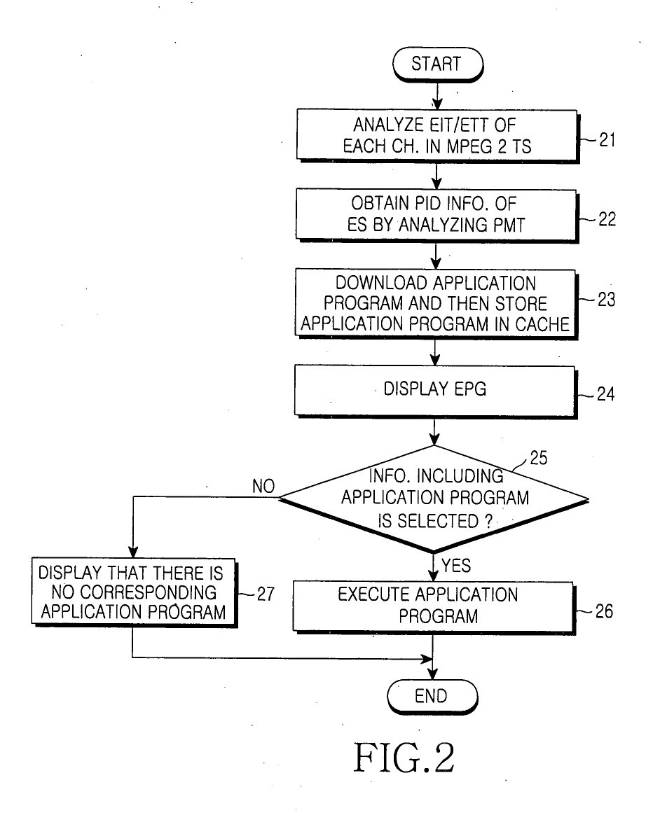

FIG. 2 is a flowchart illustrating a method for providing an electric program guide for digital broadcasting according to the teachings of the present invention.

When a digital broadcasting subscriber, via a subscriber unit, requests program information of transmitted digital broadcasting, the subscriber unit retrieves the information via an EPG function. In this case, the subscriber obtains a program time and a summary/detailed information provided through each channel by analyzing the EIT/ETT of the MPEG-2 stream through the execution of EPG function in step 21. In this case, an application program being transmitted may be determined by analyzing an AIT table relating to each channel through the execution of the EPG function.

If the application program is transmitted, a PID of the elementary stream for transmitting an object carousel is obtained by analyzing the PMT in step 22.

The subscriber unit then downloads an application program using the PID information of the obtained elementary stream and then stores the application program in a temporary storage device (e.g., a cache) in step 23.

In step 24, the subscriber unit displays the EPG information. In this case, the subscriber controls the display of the EPG information by differing the electronic program guide (EPG) information displayed with the transmission of the application program from the EPG displayed with no-transmission of the application program through a channel A.

In addition, when the subscriber selects the name of a program on a screen image of displaying the EPG information, time information and detailed information about the corresponding program are displayed. When the subscriber selects contents relating to an application program on the screen image of displaying the EPG information in step 25, and when present application programs are transmitted through corresponding channels, the names of all transmitted application programs are shown to the subscriber. When the subscriber selects one of the names of all transmitted application programs, the selected application program is executed in step 26. Herein, the execution of the selected application program denotes the provision of an initial image used for introducing the application program in the EPG information.

If contents relating to the application program are not selected in step 25, no action is performed, or alternatively, a message representing that there is no application program is displayed in step 27.

The application program may be made in such a manner that it is executed using a remote control by the subscriber. However, since an application program executed in the EPG information is used for introducing the application program to the subscriber, the EPG information shows only the initial screen image of the application program to the subscriber, and input values must be set in such a manner that the input values are not input to the application program.

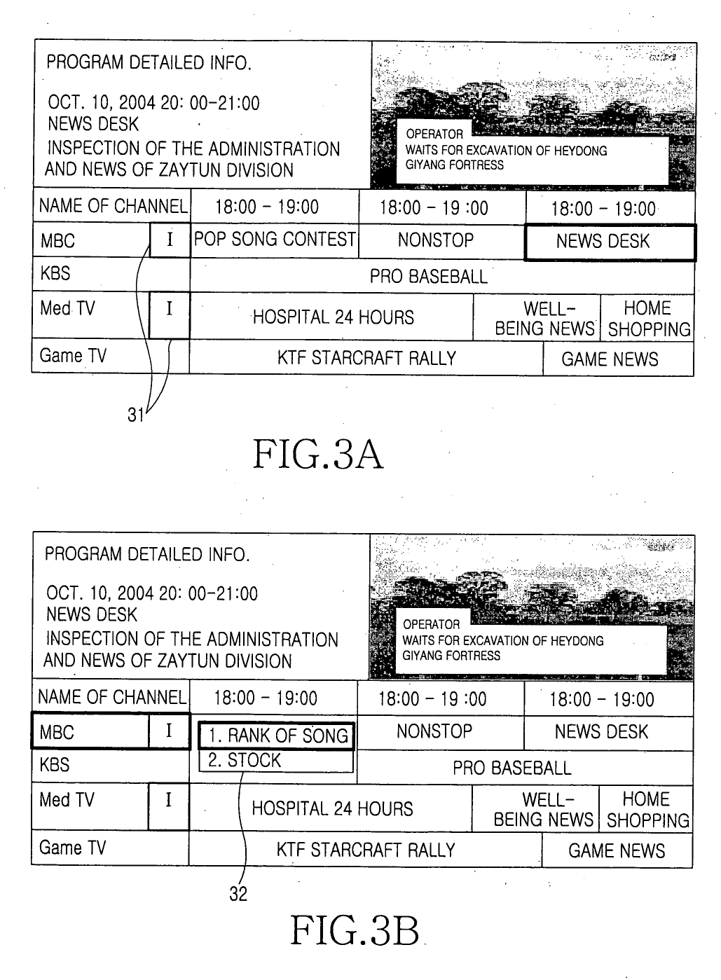

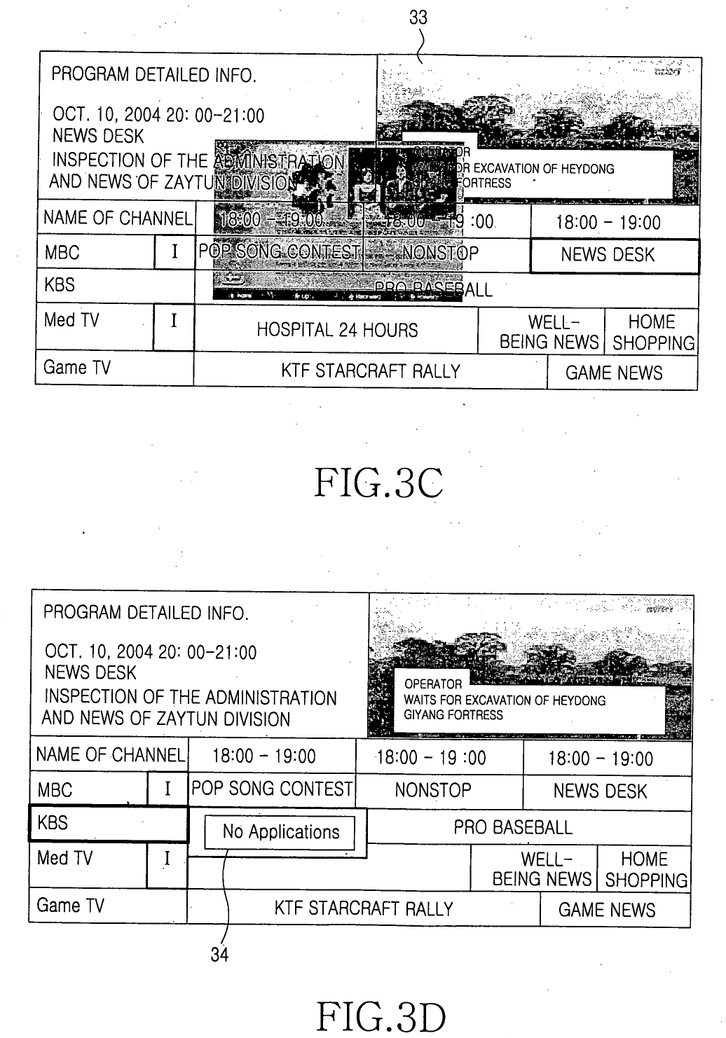

FIGS. 3A to 3D are views illustrating exemplary operation steps for providing an electric program guide for digital broadcasting according to the present invention.

FIG. 3A is a view of displaying the EPG information in step 24. In particular, reference numeral 31 informs a subscriber of the fact that the application program is being transmitted.

FIG. 3B illustrates a case in which contents relating to the application program are selected in step 25. In addition, FIG. 3B shows two application programs (1: rank of songs and 2: stock “) (reference numeral 32).

FIG. 3C illustrates a case in which the application program is executed in step 26. In this case, as described above, the execution of the selected application program denotes the provision of an initial image 33 used for introducing the application program in the EPG information.

FIG. 3D illustrates a case in which there is no application program in step 27 (reference numeral 34).

As described above, according to the present invention, it is possible to provide application program information together with program information through all channels transmitted in a digital broadcasting service. It should be noted that the present invention may be realized as program and be stored on storage media such as a CD ROM, a RAM, a floppy disk, a hard disk, and an optical magnetic disk in types which can be read by a computer.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A method for providing an electronic program guide (EPG) for digital broadcasting, the method comprising the steps of:
(1) analyzing motion picture experts group (MPEG)-2 transport stream for the digital broadcasting by a digital broadcasting receiver to execute an electronic program guide (EPG) function;
(2) obtaining a PID of an elementary stream, which transmits an object carousel, by analyzing a program map table (PMT) of the motion picture experts group (MPEG)-2 transport stream if an application program is transmitted;
(3) downloading the application program using the PID information of the elementary stream and then storing the application program in a temporary storage device;
(4) displaying electronic program guide information, via a display, to a subscriber; and
(5) executing the application program when contents relating to the application program are selected by the subscriber.

2. The method as claimed in claim 1, further comprising a step of displaying that there is no application program when contents regardless of the application program are selected in the electronic program guide information.

3. The method as claimed in claim 1, wherein, in step (1), the digital broadcasting receiver obtains time of a program and a summary/detailed information about the program is obtained by analyzing an event information table (EIT)/extended time table (ETT) of the motion picture experts group (MPEG)-2 transport stream for the digital broadcasting as the digital broadcasting subscriber executes the electronic program guide (EPG) function and determines the application program being transmitted by analyzing an application information table (AIT) relating to each channel.

4. The method as claimed in claim 1, wherein, in step (4), the electronic program guide (EPG) information displayed with a transmission of the application program is different from the EPG displayed with no-transmission of the application program.

5. The method as claimed in claim 1, wherein step (5) comprises:
(7) displaying names of all application programs transmitted through corresponding contents when the contents relating to the application program are selected; and
(8) selecting and executing one of the displayed application programs.

6. The method as claimed in claim 5, wherein, in step (8), the execution of the selected application program involves a provision of an initial image used for introducing the application program in the electronic program guide (EPG) information.
